(19) United States
(12) Patent Application Publication
(10) Pub. No.: US 2011/0276343 A1
(43) Pub. Date: Nov. 10, 2011

(54) DYNAMIC CLINICAL WORKLIST

(75) Inventors: Charles Lagor, Ardsley, NY (US); Cornelis Van Zon, Fishkill, NY (US); William P. Lord, Fishkill, NY (US)

(73) Assignee: KONINKLIJKE PHILIPS ELECTRONICS N.V., EINDHOVEN (NL)

(21) Appl. No.: 13/125,821

(22) PCT Filed: Oct. 29, 2009
(86) PCT No.: PCT/IB2009/054815

§ 371 Date: Apr. 25, 2011

Related U.S. Application Data
(60) Provisional application No. 61/111,901, filed on Nov. 6, 2008.

(51) Int. Cl. G06Q 50/00; G06Q 10/00

(52) U.S. Cl. 705/2

(57) ABSTRACT

A system and method receiving patient information entered via a user interface, processing the patient information to generate an initial worklist based on the patient information and a patient guideline, displaying the initial worklist, receiving a user input based on the initial worklist, processing the user input to generate an updated worklist based on the user input and displaying the updated worklist.

### BACKGROUND

There are many causes of medical errors, inconsistent care, sub-optimal care and prolonged durations of care. For example, medical errors and inefficiencies may result from information overload, overcrowding/understaffing, lack of a readily available specialist and the rapidly growing knowledge base in medicine. Evidence suggests that many medical errors and inefficiencies in healthcare can be avoided by standardizing clinical care through guidelines and protocols. Thus, clinical guidelines documenting a set of recommendations for healthcare professionals on how to optimally treat and manage patients with specific diseases and conditions have been developed by various medical professional organizations. Typically the recommendations by these organizations are not intended to be rigid rules, but rather are meant to be pieces of advice to guide their users.

Efforts have been made to computerize clinical guidelines and protocols since electronic versions are preferable to paper versions given the advantages of exchanging information easily with a hospital information system. Languages that specify computer-interpretable guidelines (e.g., Asbru, EON, GLIF, New Guide, PRODIGY and PROforma) are interpreted by guideline execution engines (e.g., GLEE and Gaston) that interpret the computer-interpretable guideline languages. Conventional guideline execution engines, however, restrict clinical users to a prescribed order of events. In order to overcome this limitation, case handling or work flow managing systems (e.g., FLOWer, ECHO, the Staffware Case Handler, the COSA Activity Manager) may be utilized.

Electronic guideline management systems, however, still have a number of limitations. Current systems do not account for the constantly changing tasks required in managing patients or for the importance of adapting individual workflow steps to particular situations. Additionally, these systems neither facilitate execution of the listed tasks nor give the users an opportunity to document tasks that have occurred out of the norm.

### SUMMARY OF THE INVENTION

A method including receiving patient information entered via a user interface, processing the patient information to generate an initial worklist based on the patient information and a patient guideline, displaying the initial worklist, receiving a user input based on the initial worklist; processing the user input to generate an updated worklist based on the user input and displaying the updated worklist.

A system having a user interface to enter patient information and a user input, a memory storing a patient guideline, a processor generating a worklist based on one of the patient information and the user input along with a patient guideline, wherein the user input is based on a previously generated worklist and a display displaying the worklist.

A computer-readable storage medium including a set of instructions executable by a processor. The set of instructions operable to receive patient information entered via a user interface, process the patient information to generate an initial worklist based on the patient information and a patient guideline, display the initial worklist, receive a user input based on the initial worklist, process the user input to generate an updated worklist based on the user input and display the updated worklist.

### BRIEF DESCRIPTION OF THE DRAWINGS

FIG. 1 shows a schematic diagram of a system according to an exemplary embodiment.

FIG. 2 shows a schematic diagram of a structure of the system of FIG. 1.

FIG. 3 shows a flow diagram of a method according to the system of FIG. 1.

FIG. 4 shows a screen shot of an electronic guideline and a worklist of a patient who is likely having an ischemic stroke, according to the method of FIG. 3.

FIG. 5 shows a screen shot of an electronic guideline and a worklist of a non-stroke patient exhibiting some stroke-like symptoms, according to the method of FIG. 3.

### DETAILED DESCRIPTION

The exemplary embodiments may be further understood with reference to the following description and the appended drawings wherein like elements are referred to with the same reference numerals. The exemplary embodiments relate to a system and method for interpreting a computer-readable representation of clinical guidelines. In particular, the exemplary embodiments provide a system and method for generating a user-specific list of patient-specific recommendations during a clinical routine. It will be understood by those of skill in the art that although the exemplary embodiments describe guidelines for stroke symptoms, the following systems and methods may be used to provide patient-specific recommendations for any type of symptom or clinical routine. It will also be understood by those of skill in the art that the following systems and methods may be applicable outside of the medical domain to generate recommendations based upon any accepted guideline or protocol.

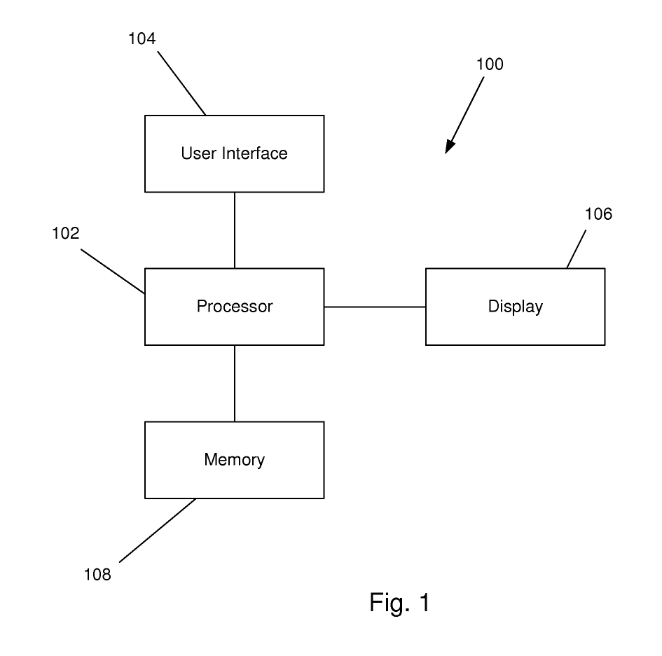

As shown in FIG. 1, a system 100 according to an exemplary embodiment generates a dynamic worklist of tasks including recommendations for a specific patient at a particular point in his/her management. The recommendations are based on existing clinical guidelines and/or protocols. The system 100 comprises a processor 102 that is capable of processing user inputs via a user interface 104 to generate the dynamic patient and/or user specific worklist. A user inputs patient information through the user interface 104 to generate an initial worklist, which is based on the guidelines and/or protocols and includes gathering patient information. Subsequent user input may optionally include user preferences and/or changes to patient information such that the processor 102 may generate an updated worklist. The system 100 further comprises a display 106 for displaying the worklist and/or a guideline flowchart and a memory 108 for storing guidelines, protocols and/or rules, which are used to generate the worklist. User input and patient information are entered via the user interface 104, which may include a mouse to point and click on items on the display 106, a touch display and/or a keyboard. The memory 108 may be any known type of computer readable storage medium. It will be understood by those of skill in the art that the system 100 is, for example, a personal computer, a server, or any other processing arrangement.

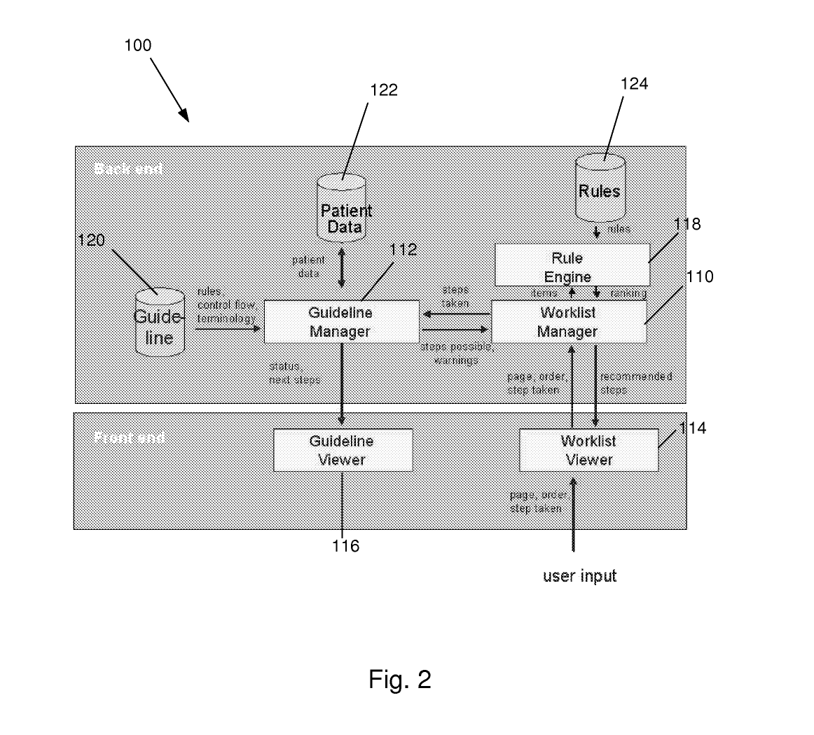

As shown in FIG. 2, the system 100, as described above, generates a dynamic worklist via software applications including a worklist manager 110 and a guideline manager 112, which are processed by the processor 102 to produce a worklist and a guideline representation, respectively, that are displayed on the display 106. Patient information is entered and stored in a patient information database 122, which is stored in the memory 108. The guideline manager 112 communicates with the patient information database 122 and a guideline database 120 to generate a guideline representation based on the patient information. The guideline database 120 includes healthcare industry-accepted guidelines and protocols that are searchable by patient information (e.g., symptoms, conditions, diseases). The guideline representation is generated via user selection by recalling a guideline from the guideline database 120. It will be understood by those of skill in the art that the accepted guidelines and protocols may be adapted for a specific site such that the guidelines and protocols may be hospital or department-accepted guidelines and protocols. The generated guideline representation includes a flowchart comprising nodes corresponding to possible steps based on the patient information.

Using the recalled guideline representation, the worklist manager 110 generates a worklist, including a list of recommended tasks, based on the patient's specific information. Both the worklist and the guideline representation are displayed via a worklist viewer 114 and a guideline viewer 116, respectively, on the display 106. Based on the displayed worklist and/or guideline representation, the user may enter user input via the user interface 104 to generate an updated worklist and/or generate a guideline representation. The user input indicates, for example, a completed task of the worklist, a request for re-ordering of the list of tasks and/or selection of a specific node of the guideline. Depending on a type of user input entered, the worklist manager 110 may communicate with one of the guideline manager 112 and/or a rules engine 118. The rules engine 118 re-orders the list of recommended tasks, as desired. The rules engine 118 consults a rules database 124, which includes a previously established set of rules that determined how to rank one task relative to another to re-order the list of recommended tasks according to the desired re-ordering. The rules database 124 is stored in the memory 108 and is consulted by the rules engine 118, as necessary. Accordingly, the worklist manager 110 is able to communicate with the guideline manager 112 and/or the rules engine 118 such that the processor 102 generates an updated worklist and/or guideline representation to be displayed on the display 106 via the worklist viewer 114 and the guideline viewer 116, respectively.

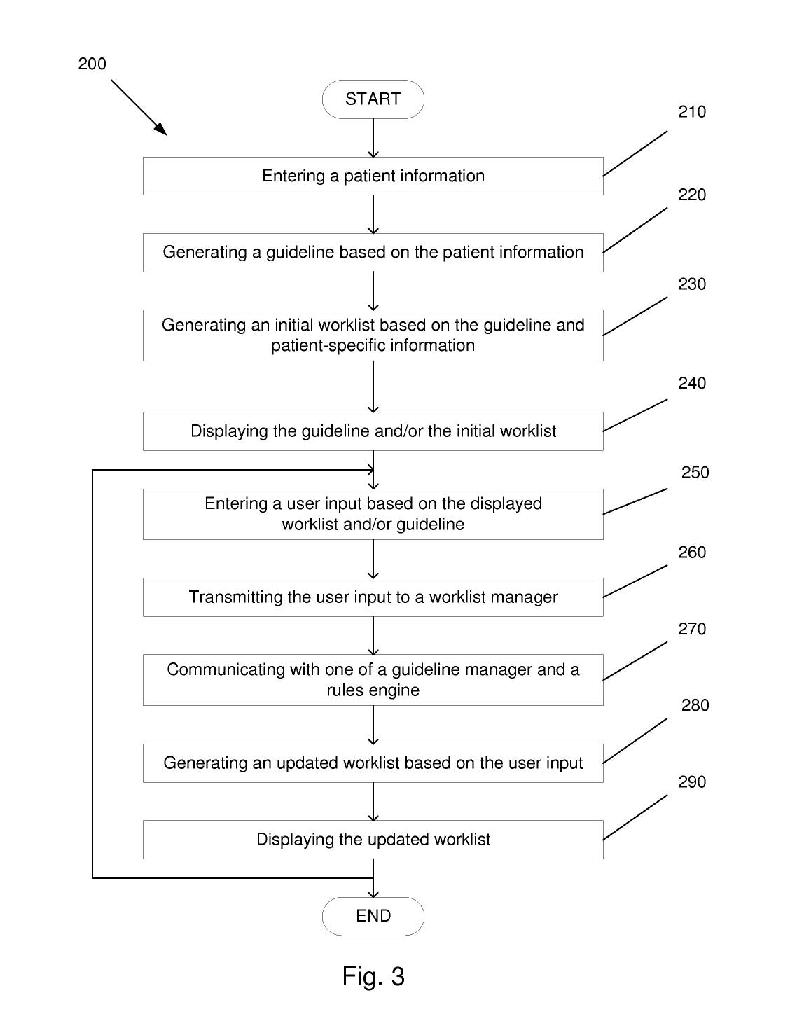

FIG. 3 shows an exemplary method 200, in which the system 100 generates a dynamic worklist, which may be continuously or iteratively updated based on changing information or specific requests. The method 200 includes entering and/or storing patient information, in a step 210. The patient information includes information such as, demographic information, the patient's symptoms, known conditions, diseases and patient findings (e.g., blood pressure, temperature). The patient information is stored in the patient information database 122 so that all of the known patient information is readily accessible by the system 100. Based on the patient information from the patient information database 122 and healthcare industry-accepted guidelines and protocols from the guideline database 120, the guideline manager 112 recalls an initial guideline representation, in a step 220. It will be understood by those of skill in the art, however, that more than one guideline representation may be recalled depending on the patient information.

The worklist manager 110 is then able to communicate with the guideline manager 112, to generate an initial worklist, based on patient-specific information and the generated guideline representation, in a step 230. The guideline may include binary decision points such that inputs for these decision points generate a list of recommended tasks for the initial worklist. Thus, the user is able to interact with the guideline via the worklist. Alternatively, the worklist manager 110 also optionally evaluates patient findings such that the worklist includes tasks for treating the finding. For example, where the user enters a systolic blood pressure of 200, the worklist manager 110 is able to determine whether the value is within a pre-defined pathological range, indicating normal, high or low values. It will be understood by those of skill in the art that the pre-defined pathological range may be defined and/or modified by the user. In one example, the worklist manager 110 determines that the systolic blood pressure value of 200 is very high such that the worklist includes a task recommending administration of an anti-hypertensive medication. As a further alternative, the worklist is user specific such that it includes a list of tasks for a specific user such as, for example, a nurse or surgeon.

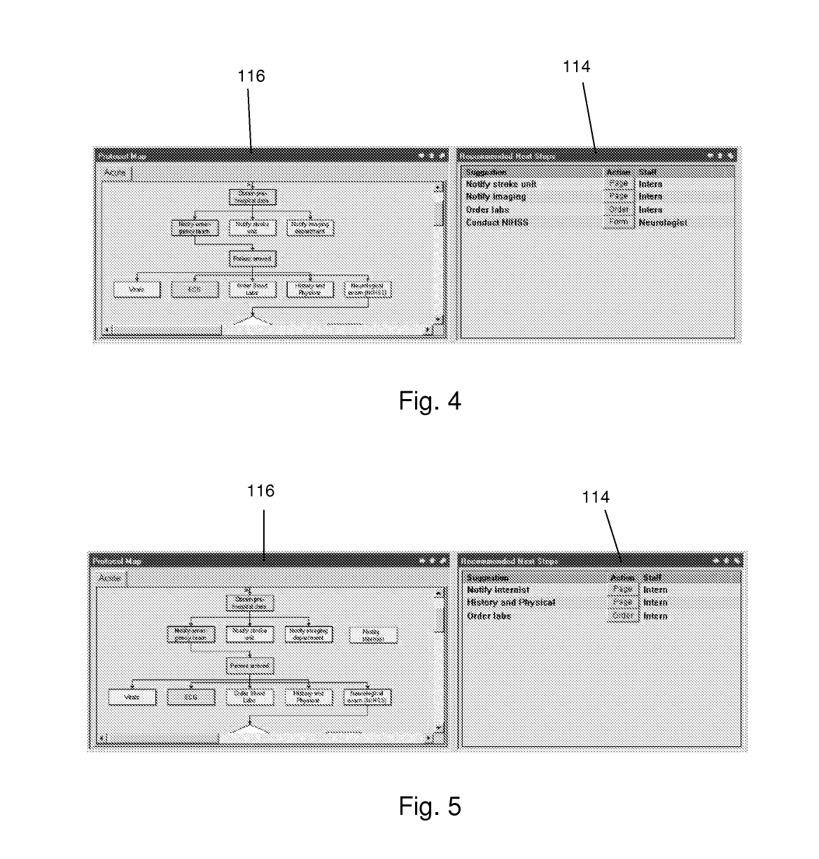

In a step 240, the initial guideline and/or the initial worklist are displayed on the display 106 via the guideline viewer 116 and the worklist viewer 114, respectively. It will also be understood by those of skill in the art that other information such as user information and/or patient information may also be displayed on the display 106, concurrently or otherwise. Although the displayed guideline may be a general, healthcare industry-accepted guideline or protocol based on patient symptoms, the worklist, which is continuously updated over the course of the patient's hospitalization, is based on patient-specific information. For example, FIG. 4 shows a guideline and worklist for a first patient. The first patient exhibits typical stroke systems (e.g., hemiparesis, visual field deficit, aphasia). The user inputs the symptoms, which are part of the patient information 122, into the system 100 and the patient information 122 is stored in the memory 108. Additionally, an ECG reveals atrial fibrillation, a common cause of ischemic stroke. Based upon the user inputted information, the worklist recommends tasks that are focused on obtaining a brain image as soon as possible, as the guideline indicates that the brain image is considered an essential step in the management of an acute ischemic stroke patient. In another example, however, as shown in FIG. 5, a patient exhibits similar symptoms such as mild slurred speech, tingling in the arm and slight dizziness. However, by the time the ECG is done, the symptoms have improved. In this case, although the guideline remains substantially the same as the guideline of FIG. 4, the list of tasks of the worklist focus on clarifying the cause of the symptoms than on obtaining a brain image since this patient is less likely to have an ischemic stroke.

In a step 250, the user enters a user input, via the user interface 104, based on the displayed initial guideline and initial worklist. The user input includes, for example, a step taken, a request for sorting the list of tasks, entering additional information about the patient such as test results and/or a request for more information or details regarding a specific node of the displayed guideline. The worklist manager 110 has a default setting, which lists the tasks in a particular order. For example, the list of tasks may be listed according to a first in—first out principle. However, the needs of a patient may change during the course of management, which may require the list to be re-ordered and sorted accordingly. The worklist may be sorted, for example, by importance, information gained, costs or risks. Sorting by importance is particularly useful if the patient has more than one medical emergency. For example, if the patient had an atrial fibrillation and a stroke episode, diagnostic steps of the stroke guideline may take precedence over an administration of a blood thinner. Additionally, the list of tasks may be sorted according to invasiveness, patient preferences or a combination of factors. It will be understood by those of skill in the art that the sorting criteria may be user-selectable, in ascending or descending order and can be reverted back to the default order suggested by the guideline. It will also be understood by those of skill in the art that the default setting for sorting may be changed by the user, as desired.

Alternatively, the user may select a specific node of the displayed guideline and/or a specific task of the displayed worklist to obtain details or further information regarding the task. For example, an explanation of the task may be shown to the user in a tool tip box. Explanations include, for example, the nature of the task, the reason why the task is on the worklist, and the reason why the item has a particular weight or importance. The explanation may further include text, pictures, and links to relevant documents and/or websites. It will be understood by those of skill in the art that the user may select the explanation option via the user interface 104 by selecting the tool tip box or hovering the mouse over an item.

The user input is then processed to generate an updated guideline representation and/or worklist based on the user input entered in the step 250. For example, in a step 260, the user input is transmitted to the worklist manager 110, which determines a step needed to update the initial worklist as indicated by the user input. Where the user input indicates a step taken, the worklist manager 110 automatically removes the completed task from the worklist. It will be understood by those of skill in the art, however, that the user may not be able to update the worklist after each task is completed. The user then simply indicates a current point in the guideline and/or worklist. The worklist manager 110 will be able to automatically infer from the current point, which tasks have been completed. It will be understood by those of skill in the art that a status of each of the tasks may be stored in the memory 108 such that the user may switch between guideline and worklists for different patients. Thus, as the user enters the user input, the status may be updated.

If, however, further processing is required, the worklist manager 110 communicates with one of the guideline manager 112 and the rules engine 118, in a step 270, depending on the user input entered. For example, if the user requests a sorting of the tasks, the worklist manager 110 communicates with the rule engine 118 to sort the list of tasks based on the rules 124. Alternatively, where the user enters additional patient information, the worklist manager 110 communicates with the guideline manager 112, which stores the additional information in the patient database 122 and updates the guideline representation based on the guidelines 120 and the additional patient information. This updated guideline representation is then communicated to the worklist manager. Further, the completion of a task may activate other tasks in the same or in another application.

In a step 280, the worklist manager 110 generates an updated worklist based on the communication between worklist manager 110 and one of the guideline manager 112 and/or the rules engine 118. The updated worklist may be updated such that the list of tasks is sorted according to a user preference or to include a new list of tasks based on additional patient information, etc. The worklist manager 110 also generates an audit trail indicating all of the tasks that have been completed thus far. In a step 290, this updated worklist and/or the updated guideline representation, if available, is then displayed on the display 106 via the worklist viewer 114 and the guideline viewer 116, respectively. Options for viewing the audit trail, patient information or other information based on the user input may also be displayed. It will be understood by those of skill in the art that the method 200 may return to the step 250 so that the user may continue to enter a user input based on the displayed guideline and/or worklist to continuously update the displayed worklist with new information or requests.

It is noted that the exemplary embodiments or portions of the exemplary embodiments may be implemented as a set of instructions stored on a computer readable storage medium, the set of instructions being executable by a processor.

It will be apparent to those skilled in the art that various modifications may be made to the disclosed exemplary embodiments and methods and alternatives without departing from the spirit or the scope of the disclosure. Thus, it is intended that the present disclosure cover modifications and variations provided they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

What is claimed is:

1. A method, comprising:
receiving (210) patient information entered via a user interface;
processing (230) the patient information to generate an initial worklist based on the patient information and a patient guideline;
displaying (240) the initial worklist;
receiving (250) a user input based on the initial worklist;
processing (280) the user input to generate an updated worklist based on the user input; and
displaying (290) the updated worklist.

2. The method of claim 1, further comprising:
receiving (250) further input based on the displayed worklist;
processing (280) the further input to generate an altered updated worklist; and
displaying (290) the altered updated worklist.

3. The method of claim 1, wherein processing the user input to generate the updated worklist includes communicating (270) with one of a guideline manager (112) and a rules engine (118).

4. The method of claim 3, wherein the guideline manager (112) generates a patient guideline representation (116) based on the patient information and an accepted healthcare industry guideline.

5. The method of claim 3, wherein the rules engine (118) includes criteria for sorting a list of tasks of the initial worklist.

6. The method of claim 1, wherein the initial worklist and the updated worklist include a list of recommended tasks (114).

7. The method of claim 6, wherein the list of recommended tasks (114) is sortable by one of importance, cost, risks, patient preferences and invasiveness.

8. The method of claim 1, further comprising:
storing the patient information in a patient information database (122).

9. The method of claim 1, wherein the patient information includes one of a patient symptom, disease, condition and test result.

10. The method of claim 1, wherein the user input includes one of an indication of completed task, a request to sort the worklist and additional patient information.

11. A system, comprising:
a user interface (104) to enter patient information and a user input;
a memory (108) storing a patient guideline;
a processor (102) generating a worklist based on one of the patient information and the user input along with a patient guideline, wherein the user input is based on a previously generated worklist; and
a display (106) displaying the worklist (114).

12. The system of claim 11, wherein the display (106) simultaneously displays a patient guideline representation (116).

13. The system of claim 11, wherein the user interface (104) receives further input based on the displayed worklist (114), the processor (102) altering the display of the patient guideline representation (116) based on the further user input.

14. The system of claim 11, wherein the worklist (114) is further based on a work function of the user.

15. The system of claim 11, wherein the memory (108) stores criteria for sorting the worklist (114) and the processor (102) sorts the worklist (114) based on the criteria.

16. The system of claim 11, wherein the worklist (114) includes a list of recommended tasks.

17. The system of claim 16, wherein the list of recommended tasks is sortable by one of importance, cost, risks, patient preferences and invasiveness.

18. The system of claim 11, wherein the patient information includes one of a patient symptom, disease, condition and test result.

19. The system of claim 11, wherein the user input includes one of an indication of a completed task, a request to sort the worklist and additional patient information.

20. A computer-readable storage medium (108) including a set of instructions executable by a processor (102), the set of instructions operable to:
receive (210) patient information entered via a user interface;
process (230) the patient information to generate an initial worklist based on the patient information and a patient guideline;
display (240) the initial worklist;
receive (250) a user input based on the initial worklist;
process (280) the user input to generate an updated worklist based on the user input; and
display (290) the updated worklist (114).
